(19) United States
(12) Patent Application Publication
(10) Pub. No.: US 2026/0260946 A1
(43) Pub. Date: Sep. 3, 2026

(54) NON-AQUEOUS ELECTROLYTE, ELECTROCHEMICAL APPARATUS, AND ELECTRONIC APPARATUS

(71) Applicant: Ningde Amperex Technology Limited, Ningde (CN)

(72) Inventors: Jianyu LIU, Ningde (CN); Hongshuai YU, Ningde (CN); Lilan Zhang, Ningde (CN); Chao TANG, Ningde (CN)

(73) Assignee: Ningde Amperex Technology Limited, Ningde (CN)

(21) Appl. No.: 19/554,677

(22) Filed: Mar. 3, 2026

(30) Foreign Application Priority Data
Mar. 3, 2025 (CN) 202510245192.0

(51) Int. Cl. H01M 10/0569; H01M 10/0525; H01M 10/0567; H01M 10/0568

(52) U.S. Cl. CPC H01M 10/0569; H01M 10/0525; H01M 10/0567; H01M 10/0568; H01M 2300/0042

(57) ABSTRACT

A non-aqueous electrolyte includes ethylene carbonate, propylene carbonate, diethyl carbonate, and propyl propionate. Based on a total mass of the non-aqueous electrolyte, mass percentages of ethylene carbonate, propylene carbonate, diethyl carbonate, and propyl propionate are A %, B %, C %, and D % respectively, 10≤A≤20, 9≤B≤15, 10≤C≤20, 10≤D≤25, and 1≤(C+D)/(A+B)≤1.3.

### CROSS-REFERENCE TO RELATED APPLICATION

This application claims the benefit of priority from the Chinese Patent Application No. 202510245192.0, filed on Mar. 3, 2025, the entire content of which is incorporated herein by reference.

### TECHNICAL FIELD

This application relates to the field of energy storage, and in particular, to a non-aqueous electrolyte, an electrochemical apparatus, and an electronic apparatus.

### BACKGROUND

Electrochemical apparatuses such as lithium-ion batteries are widely used in portable electronic products, electric vehicles, aerospace, energy storage, and other fields due to their advantages such as high energy density, good cycling performance, high safety, environmental friendliness, and no memory effect. In existing electrochemical apparatuses, as the cycle number increases, the impedance of the electrochemical apparatuses during cycling increases significantly, thereby resulting in deteriorated cycling stability.

### SUMMARY

This application provides a non-aqueous electrolyte, an electrochemical apparatus, and an electronic apparatus. When the non-aqueous electrolyte in this application is used in an electrochemical apparatus, impedance increase of the electrochemical apparatus during cycling can be significantly reduced.

In a first aspect, this application provides a non-aqueous electrolyte, including ethylene carbonate, propylene carbonate, diethyl carbonate, and propyl propionate, where based on a total mass of the non-aqueous electrolyte, mass percentages of ethylene carbonate, propylene carbonate, diethyl carbonate, and propyl propionate are A %, B %, C %, and D % respectively, 10≤A≤20, 9≤B≤15, 10≤C≤20, 10≤D≤25, and 1≤(C+D)/(A+B)≤1.3.

In the above non-aqueous electrolyte, the inventors have found that when the above non-aqueous electrolyte is used in an electrochemical apparatus, the synergy among the components of the non-aqueous electrolyte can significantly suppress the impedance increase of the electrochemical apparatus during cycling, helping improve cycling stability of the electrochemical apparatus.

In a possible implementation, the non-aqueous electrolyte further includes succinonitrile, where based on the total mass of the non-aqueous electrolyte, a mass percentage of succinonitrile is G %, and 3≤D/G≤8; and/or 2≤G≤3.5.

In the above technical solution, the introduction of succinonitrile can significantly improve floating charge performance of a battery cell.

In a possible implementation, the non-aqueous electrolyte further includes 1,3,6-hexanetricarbonitrile, where based on the total mass of the non-aqueous electrolyte, a mass percentage of 1,3,6-hexanetricarbonitrile is H %, and 2≤D/H≤7; and/or 2≤H≤4.5.

In the above technical solution, the introduction of 1,3,6-hexanetricarbonitrile can significantly improve hot-box performance of a battery cell.

In a possible implementation, the non-aqueous electrolyte further includes fluoroethylene carbonate and/or 1,3-propane sultone.

In the above technical solution, when the non-aqueous electrolyte is used in an electrochemical apparatus, fluoroethylene carbonate and 1,3-propane sultone in the non-aqueous electrolyte can protect the positive electrode and the negative electrode of the electrochemical apparatus, thereby improving high-temperature cycling performance of the electrochemical apparatus.

In a possible implementation, based on the total mass of the non-aqueous electrolyte, a mass percentage of fluoroethylene carbonate is E %, and 2≤E≤4; and/or based on the total mass of the non-aqueous electrolyte, a mass percentage of 1,3-propane sultone is F %, and 2≤F≤3.5.

In a possible implementation, the non-aqueous electrolyte further includes lithium tetrafluoroborate, where based on the total mass of the non-aqueous electrolyte, a mass percentage of lithium tetrafluoroborate is I %, and 0.01≤I≤0.2.

In the above technical solution, adding lithium tetrafluoroborate to the non-aqueous electrolyte can improve high-temperature storage performance and cycle life of the electrochemical apparatus.

In a possible implementation, the non-aqueous electrolyte further includes trimethylacetonitrile and/or fluoroacetonitrile.

In the above technical solution, trimethylacetonitrile and fluoroacetonitrile in the non-aqueous electrolyte have a relatively low viscosity, which can improve kinetic performance of the non-aqueous electrolyte; in addition, trimethylacetonitrile and fluoroacetonitrile can also improve stability of the positive electrode in the electrochemical apparatus, helping improve high-temperature cycling performance of the electrochemical apparatus.

In a possible implementation, based on the total mass of the non-aqueous electrolyte, a mass percentage of trimethylacetonitrile is J %, and 0.1≤J≤0.5; and/or based on the total mass of the non-aqueous electrolyte, a mass percentage of fluoroacetonitrile is K %, and 0.1≤K≤5.

In a second aspect, this application provides an electrochemical apparatus, including a positive electrode, a negative electrode, and the above non-aqueous electrolyte. Therefore, impedance increase of the electrochemical apparatus provided in this application can be effectively suppressed during cycling.

In a possible implementation, the positive electrode includes a positive electrode current collector and a positive electrode active material layer located on at least one surface of the positive electrode current collector; the positive electrode active material layer includes a doping element, where the doping element includes at least one of the titanium element, the magnesium element, or the aluminum element; and based on a total mass of the positive electrode, a content of the doping element is M ppm, and 4000≤M≤8500.

In the above technical solution, when the positive electrode active material layer contains a doping element of a specific content. Synergy between the doping element of a specific content and the non-aqueous electrolyte can reduce the impedance increase of the electrochemical apparatus during cycling, and improve the cycling stability of the electrochemical apparatus. In addition, when a specific doping element is included, stability of the positive electrode can be improved. In this case, the high-temperature cycling performance of the electrochemical apparatus is improved.

In a third aspect, this application provides an electronic apparatus, including the above electrochemical apparatus. Therefore, the electronic apparatus provided in this application exhibits good performance.

### Beneficial Effects of this Application

This application provides a non-aqueous electrolyte, an electrochemical apparatus, and an electronic apparatus, where the non-aqueous electrolyte includes ethylene carbonate, propylene carbonate, diethyl carbonate, and propyl propionate, where based on a total mass of the non-aqueous electrolyte, mass percentages of ethylene carbonate, propylene carbonate, diethyl carbonate, and propyl propionate are A %, B %, C %, and D % respectively, 10≤A≤20, 9≤B≤15, 10≤C≤20, 10≤D≤25, and 1≤(C+D)/(A+B)≤1.3. The components in the non-aqueous electrolyte and the contents of the components are controlled, so that the impedance increase of the electrochemical apparatus during cycling can be greatly reduced.

### DETAILED DESCRIPTION

To make the objectives, technical solutions, and advantages of the embodiments of this application clearer, the technical solutions in some embodiments of this application are clearly and completely described below. The embodiments that do not indicate specific conditions are carried out according to conventional conditions or conditions recommended by manufacturers. Reagents or instruments that do not indicate the manufacturers are conventional products that can be purchased commercially.

The non-aqueous electrolyte, electrochemical apparatus, and electronic apparatus in some embodiments of this application are specifically described below.

In a first aspect, this application provides a non-aqueous electrolyte, including ethylene carbonate, propylene carbonate, diethyl carbonate, and propyl propionate, where based on a total mass of the non-aqueous electrolyte, mass percentages of ethylene carbonate, propylene carbonate, diethyl carbonate, and propyl propionate are A %, B %, C %, and D % respectively, 10≤A≤20, 9≤B≤15, 10≤C≤20, 10≤D≤25, and 1≤(C+D)/(A+B)≤1.3. For example, A may be 10, 12, 16, 18, 20, or the like, or within a range defined by any two of the above values; B may be 9, 10, 12, 13, 15, or the like, or within a range defined by any two of the above values; C may be 10, 12, 14, 16, 18, 20, or the like, or within a range defined by any two of the above values; D may be 10, 13, 15, 18, 20, 22, 25, or the like, or within a range defined by any two of the above values; or (C+D)/(A+B) may be 1, 1.1, 1.2, 1.3, or the like, or within a range defined by any two of the above values. The non-aqueous electrolyte in this application may be used in an electrochemical apparatus to transport lithium ions and electrons and ensure the formation of a path inside the electrochemical apparatus.

The inventors have found that although ethylene carbonate and propylene carbonate have relatively high conductivity, they have relatively high viscosities, which hinders improvement of the kinetic performance of the electrochemical apparatus; while diethyl carbonate and propyl propionate have lower viscosities but poor oxidation resistance, which is unfavorable for maintaining stability of the positive electrode in the electrochemical apparatus. When ethylene carbonate and propylene carbonate are used in combination with diethyl carbonate and propyl propionate, their mass percentages are within the above ranges, and their usage relationship is within the above range, the non-aqueous electrolyte can significantly reduce impedance increase in the electrochemical apparatus during cycling, which helps improve cycling stability of the electrochemical apparatus.

In some embodiments of this application, to improve floating charge performance of the electrochemical apparatus, the non-aqueous electrolyte further includes succinonitrile, where based on the total mass of the non-aqueous electrolyte, a mass percentage of succinonitrile is G %, and 3≤D/G≤8; and/or 2≤G≤3.5. Specifically, D/G may be 3, 4, 5, 6, 7, 8, or the like, or within a range defined by any two of the above values; G may be 2, 2.2, 2.5, 3, 3.5, or the like, or within a range defined by any two of the above values.

In some embodiments of this application, to improve hot-box performance of the electrochemical apparatus, the non-aqueous electrolyte further includes 1,3,6-hexanetricarbonitrile, where based on the total mass of the non-aqueous electrolyte, a mass percentage of 1,3,6-hexanetricarbonitrile is H %, and 2≤D/H≤7; and/or 2≤H≤4.5. Specifically, D/H may be 2, 3, 4, 5, 6, 7, or the like, or within a range defined by any two of the above values; H may be 2, 2.5, 3, 3.5, 4, 4.5, or the like, or within a range defined by any two of the above values.

In addition, in some embodiments of this application, the non-aqueous electrolyte further includes fluoroethylene carbonate and/or 1,3-propane sultone. Fluoroethylene carbonate and 1,3-propane sultone can protect the positive electrode and the negative electrode of the electrochemical apparatus, thereby improving the high-temperature cycling performance of the electrochemical apparatus. Based on the total mass of the non-aqueous electrolyte, the mass percentage of fluoroethylene carbonate is E %, and a mass percentage of 1,3-propane sultone is F %, preferably 2≤E≤4, and 2≤F≤3.5. Specifically, E may be 2, 2.5, 3, 3.5, 4, or the like, or within a range defined by any two of the above values; and F may be 2, 2.2, 2.8, 3, 3.2, 3.5, or the like, or within a range defined by any two of the above values.

In addition, in some embodiments of this application, to improve high-temperature storage performance and prolong a cycle life of the electrochemical apparatus, the non-aqueous electrolyte further includes lithium tetrafluoroborate, where based on the total mass of the non-aqueous electrolyte, a mass percentage of lithium tetrafluoroborate is I %, and 0.01≤I≤0.2. Specifically, I may be 0.01, 0.05, 0.08, 0.1, 0.15, 0.2, or the like, or within a range defined by any two of the above values.

In addition, in some embodiments of this application, the non-aqueous electrolyte further includes trimethylacetonitrile and/or fluoroacetonitrile. Trimethylacetonitrile and fluoroacetonitrile have a relatively low viscosity, which can improve kinetic performance of the non-aqueous electrolyte, and can also improve the stability of the positive electrode in the electrochemical apparatus. This helps improve the high-temperature cycling performance of the electrochemical apparatus. Based on the total mass of the non-aqueous electrolyte, mass percentages of trimethylacetonitrile and fluoroacetonitrile are J % and K % respectively, preferably 0.1≤J≤0.5, and 0.1≤K≤5. Specifically, J may be 0.1, 0.2, 0.3, 0.4, 0.5, or the like, or within a range defined by any two of the above values, and K may be 0.1, 0.5, 1, 1.5, 2, 3, 4.5, 5, or the like, or within a range defined by any two of the above values.

In a second aspect, this application further provides an electrochemical apparatus, including a positive electrode, a negative electrode, and the non-aqueous electrolyte according to this application. Therefore, impedance increase during the cycling of the electrochemical apparatus of this application can be effectively suppressed. Moreover, it should be noted that in the subsequent specific embodiments of this application, a lithium-ion secondary battery (that is, lithium-ion battery) is taken as an example of the electrochemical apparatus to explain this application, but the electrochemical apparatus in this application is not limited to a lithium-ion secondary battery. For example, the electrochemical apparatus in this application may include but is not limited to a lithium metal secondary battery, a lithium polymer secondary battery, or a lithium-ion polymer secondary battery (that is, lithium-ion polymer battery), or the like.

Besides the non-aqueous electrolyte, structures of the various parts of the electrochemical apparatus in this application are as follows.

### Positive Electrode

The positive electrode (also referred to as “positive electrode plate”) includes a positive electrode current collector and a positive electrode active material layer provided on at least one surface of the positive electrode current collector. That is, in this application, the positive electrode active material layer may be provided on one surface in a thickness direction of the positive electrode current collector or on two surfaces in the thickness direction of the positive electrode current collector. Moreover, in this application, “surface of the positive electrode current collector” may be the entire area of the positive electrode current collector or a partial area of the positive electrode current collector. This is not particularly limited in this application as long as the objective of this application can be achieved.

In some embodiments of this application, the positive electrode active material layer includes a doping element, and the doping element may be at least one of the titanium element, the magnesium element, or the aluminum element; and based on the total mass of the positive electrode, a content of the doping element is M ppm, and 4000≤M≤8500.

The inventors have found that when the positive electrode contains the above doping element, although the cycling performance of the electrochemical apparatus can be improved, the impedance increase during the cycling of the electrochemical apparatus is more significant; therefore, when the content of the doping element is within the above range, the synergy between the doping element and the non-aqueous electrolyte of this application can maintain the high cycling performance of the electrochemical apparatus, reduce impedance increase during the cycling of the electrochemical apparatus, and improve the high-temperature cycling performance of the electrochemical apparatus.

The components of the positive electrode active material layer include a positive electrode active substance, and the positive electrode active substance may be any substance capable of reversibly intercalating and deintercalating alkali metal ions such as Li⁺ and Na⁺ to ensure normal charge and discharge of the electrochemical apparatus, and the doping element is generally provided by the positive electrode active substance. For example, the positive electrode active substance includes but is not limited to at least one of lithium iron phosphate (LiFePO₄), lithium cobalt oxide (LiCoO₂), lithium manganese oxide, lithium nickel oxide, or ternary material, and the ternary material includes but is not limited to at least one of LiNiₓCo_{y}Mn_{z}O₂, LiNiₓCo_{y}Al_{z}O₂, or the like, and contents of Ni, Co, Mn, Al, or the like can be adjusted as long as x+y+z=1. For example, the ternary material may be LiNi_{0.6}Co_{0.2}Mn_{0.2}O₂, LiNi_{0.88}Co_{0.08}Mn_{0.04}O₂, LiNi_{0.8}Co_{0.15}Mn_{0.05}O₂, LiNi_{0.8}Co_{0.1}Mn_{0.1}O₂, LiNi_{0.88}Co_{0.1}Mn_{0.02}O₂, LiNi_{0.8}Co_{0.15}Al_{0.05}O₂, LiNi_{0.88}Co_{0.1}Al_{0.02}O₂, or the like.

In some embodiments, the components of the positive electrode active material layer further include a positive electrode conductive agent. A type of the positive electrode conductive agent is not limited in this application, and any known conductive material may be used. Specifically, the positive electrode conductive agent includes but is not limited to at least one of carbon black such as acetylene black and Super-P, materials such as amorphous carbon like needle coke, carbon nanotubes, or graphene.

In some embodiments, the components of the positive electrode active material layer generally further contain a positive electrode binder. A type of the positive electrode binder used in the manufacture of the positive electrode active material layer is not particularly limited. In the case where a coating method is used, any material that can be dissolved or dispersed in a liquid medium used in electrode manufacture may be used. The positive electrode binder includes but is not limited to one or at least two of the following: resin-based polymers such as polyethylene, polypropylene, polyethylene terephthalate, polymethyl methacrylate, polyimide, aromatic polyamide, cellulose, and nitrocellulose; rubbery polymers such as styrene-butadiene rubber (SBR), nitrile-butadiene rubber (NBR), fluororubber, isoprene rubber, polybutadiene rubber, and ethylene-propylene rubber; thermoplastic elastomer-like polymers such as styrene-butadiene-styrene block copolymer or its hydrogenated product, ethylene-propylene-diene terpolymer (EPDM), styrene-ethylene-butadiene-ethylene copolymer, and styrene-isoprene-styrene block copolymer or its hydrogenated product; soft resin-like polymers such as syndiotactic-1,2-polybutadiene, polyvinyl acetate, ethylene-vinyl acetate copolymer, and propylene-α-olefin copolymer; fluorinated polymers such as polyvinylidene fluoride (PVDF), polytetrafluoroethylene, fluorinated polyvinylidene fluoride, and polytetrafluoroethylene-ethylene copolymer; and polymer compositions having ionic conductivity of alkali metal ions (especially lithium ions).

In the positive electrode, a type of the positive electrode current collector is not particularly limited, and may be any known material suitable for use as a positive electrode current collector. A material of the positive electrode current collector includes but is not limited to metal materials such as aluminum, stainless steel, nickel plating, titanium, and tantalum. In addition, to reduce an electronic contact resistance between the positive electrode current collector and the positive electrode active material layer, a conductive aid, a conductive coating layer, or the like may be provided on the surface of the positive electrode current collector. The conductive aid includes but is not limited to carbon and noble metals such as gold, platinum, and silver. The conductive coating layer may be a mixture layer of inorganic oxide, conductive agent, and positive electrode binder.

In preparation of the positive electrode, the components in the above positive electrode active material layer may be dissolved or dispersed in a liquid solvent to prepare a positive electrode slurry, and then the positive electrode slurry is applied to the positive electrode current collector and dried, thereby forming a positive electrode active material layer on the positive electrode current collector. In this case, a positive electrode can be obtained. In preparation of the positive electrode in this manner, the solvent in the positive electrode slurry is not particularly limited as long as it can dissolve or disperse the above components. Specifically, the solvent in the positive electrode slurry includes but is not limited to N-methylpyrrolidone (NMP), ethylene carbonate (EC), or the like. In addition, in preparation of the positive electrode, the components in the positive electrode active material layer may be dry-mixed to form a sheet, and then the obtained sheet is pressure-bonded to the positive electrode current collector.

### Negative Electrode

The negative electrode (also referred to as “negative electrode plate”) includes a negative electrode current collector and a negative electrode active material layer provided on at least one surface of the negative electrode current collector, and the components of the negative electrode active material layer include a negative electrode active substance. That is, in this application, the negative electrode active material layer may be provided on one surface in a thickness direction of the negative electrode current collector or on two surfaces in the thickness direction of the negative electrode current collector. Moreover, in this application, “surface of the negative electrode current collector” may be the entire area of the negative electrode current collector or a partial area of the negative electrode current collector. This is not particularly limited in this application as long as the objective of this application can be achieved.

The negative electrode active material layer generally contains a negative electrode active material. The negative electrode active material is not particularly limited in this application. Specifically, the negative electrode active material may include at least one of a carbon material or a silicon-based material. More specifically, the carbon material includes but is not limited to at least one of natural graphite, artificial graphite, mesocarbon microbeads, hard carbon, or soft carbon; and the silicon-based material includes but is not limited to at least one of silicon, silicon-oxygen composite material, or silicon-carbon composite material.

In some embodiments, the negative electrode active material layer generally further contains a negative electrode conductive agent. A type of the negative electrode conductive agent is not particularly limited in this application as long as the objective of this application can be achieved. For example, the negative electrode conductive agent includes but is not limited to at least one of acetylene black, Ketjen black, carbon nanotubes, carbon fibers, carbon dots, or graphene.

In some embodiments, the negative electrode active material layer may also contain a negative electrode binder and a thickener. Types of the negative electrode binder and the thickener are not particularly limited in this application as long as the objective of this application can be achieved. For example, the negative electrode binder may include but is not limited to at least one of polyvinyl alcohol, polyvinyl chloride, carboxylated polyvinyl chloride, polyvinyl fluoride, polyvinylpyrrolidone, polyurethane, polytetrafluoroethylene, polyvinylidene fluoride, styrene-butadiene rubber, or acrylated styrene-butadiene rubber; and the thickener in the negative electrode slurry may include but is not limited to at least one of sodium carboxymethyl cellulose or lithium carboxymethyl cellulose.

In the negative electrode, the material of the negative electrode current collector includes but is not limited to copper foil, nickel foil, stainless steel foil, titanium foil, foamed nickel, foamed copper, or a polymer substrate coated with a conductive metal. This is not particularly limited in this application. The conductive metal includes but is not limited to copper, nickel, or titanium, and a material of the polymer substrate includes but is not limited to at least one of polyethylene, polypropylene, ethylene-propylene copolymer, polyethylene terephthalate, polyethylene naphthalate, or poly(p-phenylene terephthalamide).

In addition, in this application, thicknesses of the negative electrode current collector and the negative electrode active material layer are not particularly limited as long as the objective of this application can be achieved. For example, the thickness of the negative electrode current collector is 4 μm to 12 μm, and the thickness of one negative electrode active material layer is 30 μm to 160 μm.

In addition, similar to the preparation of the positive electrode, in preparation of the negative electrode, a negative electrode slurry may be prepared, and then the negative electrode slurry is applied to the negative electrode current collector and dried, thereby forming a negative electrode active material layer on the negative electrode current collector to obtain a negative electrode; alternatively, the components in the negative electrode active material layer may be dry-mixed to form a sheet, and then the obtained sheet is pressure-bonded to the negative electrode current collector to form a negative electrode active material layer. In this way, a negative electrode is obtained. The solvent in the negative electrode slurry includes any one of an aqueous solvent or an organic solvent. The aqueous solvent includes but is not limited to water, a mixed solvent of alcohol and water, or the like. The organic solvent includes but is not limited to aliphatic hydrocarbons such as hexane; aromatic hydrocarbons such as benzene, toluene, xylene, and methylnaphthalene; heterocyclic compounds such as quinoline and pyridine; ketones such as acetone, methyl ethyl ketone, and cyclohexanone; esters such as methyl acetate and methyl acrylate; amines such as diethylene triamine and N,N-dimethylaminopropylamine; ethers such as diethyl ether, propylene oxide, and tetrahydrofuran (THF); amides such as N-methylpyrrolidone (NMP), dimethylformamide, and dimethylacetamide; and aprotic polar solvents such as hexamethylphosphoramide and dimethyl sulfoxide. In addition, in some other embodiments, when an aqueous solvent is used, the components of the negative electrode slurry further include a thickener and a styrene-butadiene rubber (SBR) emulsion to slurry the negative electrode slurry, thereby adjusting a viscosity of the negative electrode slurry. Types of the thickener in the positive electrode slurry include but are not limited to at least one of carboxymethyl cellulose, methyl cellulose, hydroxymethyl cellulose, ethyl cellulose, polyvinyl alcohol, oxidized starch, phosphorylated starch, casein, and salts thereof.

### Separator

To prevent short circuit, a separator is usually provided between the positive electrode and the negative electrode. In this case, the electrolyte in this application is usually used for infiltrating the separator.

A material and a shape of the separator are not particularly limited as long as the effect of this application is not significantly impaired. The material of the separator may be resin, glass fiber, inorganic substance, or the like formed of a material stable to the electrolyte of this application. In some embodiments, the separator includes a porous sheet, non-woven fabric-like substance, or the like excellent in electrolyte retention. Examples of the material of the resin or glass fiber separator include but are not limited to polyolefins, aromatic polyamides, polyimides (PI), polyamides (PA), polytetrafluoroethylene, polyethersulfone, spandex, or aramid. In some embodiments, the polyolefin is polyethylene or polypropylene. In some embodiments, the polyolefin is polypropylene. The above separator materials may be used alone or in any combination.

The separator may alternatively be a material obtained by stacking the above materials, and examples thereof include, but are not limited to, a three-layer separator or the like obtained by sequentially stacking polypropylene, polyethylene, and polypropylene.

A material of the inorganic substance includes but is not limited to oxides such as alumina and silica, nitrides such as aluminum nitride and silicon nitride, and sulfates (for example, barium sulfate and calcium sulfate). A form of the inorganic substance includes but is not limited to a granular or fibrous form.

A form of the separator may be a film form, including but not limited to non-woven fabric, woven fabric, microporous film, or the like. For the film form, a pore size of the separator is 0.01 μm to 1 μm, and a thickness is 5 μm to 50 μm. In addition to the above independent film-like separator, the following separator may also be used: a separator formed by forming a composite porous layer containing the above inorganic substance particles on the surface of the positive electrode and/or negative electrode using a resin-based binder, for example, a separator formed by forming a porous layer containing alumina particles with 90% particle size less than 1 μm on two sides of the positive electrode using a fluororesin as a binder.

A thickness of the separator is arbitrary. In some embodiments, the thickness of the separator is greater than 1 μm, greater than 5 μm, or greater than 8 μm. In some embodiments, the thickness of the separator is less than 50 μm, less than 40 μm, or less than 30 μm. When the thickness of the separator is within the above range, insulation and mechanical strength can be ensured, and the rate characteristic and cycling performance of the electrochemical apparatus can be ensured.

In this application, the separator may include a substrate and a surface treatment layer. The substrate may be a non-woven fabric or a composite film having a porous structure, and the material of the substrate may include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used. Optionally, a surface treatment layer is provided on at least one surface of the substrate, and the surface treatment layer may be a polymer layer or an inorganic substance layer, or a layer formed by mixing a polymer and an inorganic substance. For example, the inorganic substance layer includes an inorganic particle and a binder, and the above inorganic particle is not particularly limited in this application, for example, it may include at least one of alumina, silica, magnesia, titania, hafnia, tin oxide, ceria, nickel oxide, zinc oxide, calcium oxide, zirconia, yttria, silicon carbide, boehmite, aluminum hydroxide, magnesium hydroxide, calcium hydroxide, or barium sulfate. The above binder is not particularly limited in this application in this application, for example, it may be at least one of the aforementioned binders. The polymer layer contains a polymer, and a material of the polymer includes at least one of polyamide, polyacrylonitrile, acrylate polymer, polyacrylic acid, polyvinylpyrrolidone, polyvinyl ether, polyvinylidene fluoride, or poly(vinylidene fluoride-hexafluoropropylene).

The electrochemical apparatus in this application further includes a packaging bag for accommodating the positive electrode, the separator, the negative electrode, and the electrolyte, as well as other components in the electrochemical apparatus known in the art, and the above other components are not limited in this application. The packaging bag is not particularly limited in this application, and it may be any packaging bag known in the art as long as the objective of this application can be achieved.

In a third aspect, this application further provides an electronic apparatus, including the electrochemical apparatus according to this application.

The use of the electrochemical apparatus in this application is not specifically limited, and it may be used in any electronic apparatus known in the prior art. In some embodiments, the electrochemical apparatus of this application may be used for, but not limited to, notebook computers, pen-input computers, mobile computers, e-book players, portable telephones, portable fax machines, portable copiers, portable printers, stereo headphones, video recorders, liquid crystal displays, portable cleaners, portable CD players, mini discs, transceivers, electronic notebooks, calculators, memory cards, portable recorders, radios, backup power supplies, motors, automobiles, motorcycles, power-assisted bicycles, bicycles, lighting fixtures, toys, game consoles, clocks, electric tools, flashlights, cameras, large household batteries, lithium-ion capacitors, and the like.

### EXAMPLES

Hereinafter, a lithium-ion secondary battery is taken as an example, and examples and comparative examples are given to more specifically explain the embodiments of the electrochemical apparatus in this application. Those skilled in the art should understand that the preparation methods described in this application are only examples, and any other suitable preparation methods are within the scope of this application.

### Test Methods and Devices

### Test for Impedance Increase During Cycling

The impedance increase during cycling of the lithium-ion battery was evaluated based on an impedance increase rate after 400 cycles at 45° C. A smaller impedance increase rate after 400 cycles at 45° C. indicated better performance of suppressing the increase in the lithium-ion battery during cycling.

The lithium-ion battery was placed in a 45° C. constant temperature chamber and left standing for 30 minutes to bring the lithium-ion battery to a constant temperature. The lithium-ion battery that reached the constant temperature was charged at 45° C. with a constant current of 0.2 C to 4.5V; charged at a constant voltage of 4.5V to 0.05 C, and left standing for 5 minutes; and then discharged at a constant current of 0.2 C for 4 hours, and left standing for 5 minutes. An initial direct-current impedance R₀ of the lithium-ion battery was tested. Then the battery was charged at a constant current of 1.8 C to 4.15V; charged at a constant voltage of 4.15V to the current of 1 C; then charged at a constant current of 1 C to 4.25V; then charged at a constant voltage of 4.25V to the current of 0.8 C; then charged at a constant current of 0.8 C to 4.5V; then charged at a constant voltage of 4.5V to the current of 0.05 C, and left standing for 5 minutes; and then discharged at a constant current of 1 C to 3.0V, and left standing for 5 minutes. This was one charge/discharge cycle. The above charge/discharge cycle steps were performed for 400 cycles. The lithium-ion battery was charged at 45° C. with a constant current of 0.2 C to 4.5V; charged at a constant voltage of 4.5V to 0.05 C, and left standing for 5 minutes; and then discharged at a constant current of 0.2 C for 4 hours, and left standing for 5 minutes. A direct-current impedance R₁ of the lithium-ion battery after 400 cycles was tested.

Herein, impedance increase rate after 400 cycles at 45° C.=(R₁/R₀−1)×100%. A smaller impedance increase rate after 400 cycles at 45° C. indicated better performance of suppressing impedance increase in the lithium-ion battery during cycling. The specific data of the impedance increase rates during high-temperature cycling of the lithium-ion batteries in the examples and comparative examples are shown in “Impedance increase rate after 400 cls at 45° C. (%)” in Tables 1 to 7.

A method for testing direct-current impedance: the lithium-ion battery was charged at a constant current of 0.2 C to 4.5V; then charged at a constant voltage of 4.5V to the current of 0.05 C; then discharged at a constant current of 0.2 C for 4 hours until the state of charge (SOC) of the lithium-ion battery was 20%; discharged at 0.1 C for 10 seconds to obtain voltage V₀; and discharged at 1 C for 1 second to obtain voltage V₁, where the direct-current impedance R=(V₀−V₁)/0.1 C.

### Test for Cycling Capacity Retention Performance at High-Temperature (45° C.)

The cycling performance of the lithium-ion battery was evaluated based on a capacity retention rate after 400 cycles at 45° C. A higher capacity retention rate after 400 cycles at 45° C. indicated better cycling performance of the lithium-ion battery.

The lithium-ion battery was placed in a 45° C. constant temperature chamber and left standing for 30 minutes to bring the lithium-ion battery to a constant temperature. The lithium-ion battery that reached the constant temperature was charged at 45° C. with a constant current of 0.2 C to 4.5V; charged at a constant voltage of 4.5V to 0.05 C; left standing for 5 minutes; then discharged at a constant current of 0.2 C to 3.0V; and left standing for 5 minutes. An initial discharge capacity C₀ of the lithium-ion battery was tested. Then the battery was charged at a constant current of 1.8 C to 4.15V; charged at a constant voltage of 4.15V to the current of 1 C; then charged at a constant current of 1 C to 4.25V; then charged at a constant voltage of 4.25V to the current of 0.8 C; then charged at a constant current of 0.8 C to 4.5V; then charged at a constant voltage of 4.5V to the current of 0.05 C; left standing for 5 minutes; then discharged at a constant current of 1 C to 3.0V; and left standing for 5 minutes. This was one charge/discharge cycle. The charge/discharge cycle steps were performed for 400 cycles, and a discharge capacity C₁ of the lithium-ion battery after 400 cycles was measured.

Herein, capacity retention rate after 400 cycles at 45° C.=C₁/C₀×100%. A higher capacity retention rate after 400 cycles at 45° C. indicated better high-temperature cycling performance of the lithium-ion battery. The specific data of the high-temperature cycling performance in the lithium-ion batteries of the examples and comparative examples are shown in “Capacity retention rate after 400 cls at 45° C. (%)” in Tables 1 to 7.

### Test for Floating Charge Performance

At 45° C., the lithium-ion battery was charged at a constant current of 0.7 C to 4.5V; and then charged at a constant voltage for 90 days. A thickness of the battery was measured and recorded with a micrometer, and the thickness of the lithium-ion battery was tested and recorded every 3 days. A floating charge thickness swelling rate of the battery was calculated according to the following formula, and a time at which the thickness swelling rate reached 10% was used as an indicator to evaluate the floating charge performance of the lithium-ion battery:

thickness swelling rate=(thickness during floating charge−initial thickness)/initial thickness×100%; where the specific data are shown in “40 D floating charge at 45° C. (%)” in the table.

### Hot-Box Test

At 25° C., the lithium-ion battery was charged at a constant current of 0.7 C to 4.5V and charged at a constant voltage of 4.5V to the current of 0.05 C. The battery was placed in a high-temperature chamber, heated to 135° C. at a temperature rise rate of 5±2° C./min, and then held for 1 hour. Changes in the voltage and temperature of the battery and hot-box temperature were recorded. Whether the lithium-ion battery caught fire was observed. If it did not catch fire, it passed the hot-box test. Ten batteries were tested in each example and comparative example, and results were recorded.

### Example 1-1

### <Preparation of Electrolyte>

In an argon atmosphere glove box with a water content less than 10 ppm, methyl ethyl carbonate and ethyl acetate were mixed in a mass ratio of 1:1 to prepare a base solvent, and then lithium salt lithium hexafluorophosphate (LiPF₆), ethylene carbonate, propylene carbonate, diethyl carbonate, and propyl propionate were added to form an electrolyte. Based on a total mass of the electrolyte, a mass percentage of LiPF₆ was 12.5%, mass percentages of ethylene carbonate, propylene carbonate, diethyl carbonate, and propyl propionate are shown in Table 1. The balance was the base solvent.

### <Preparation of Positive Electrode>

Lithium cobalt oxide, conductive agent conductive carbon black, and polyvinylidene fluoride (PVDF) were mixed in a mass ratio of 95:2:3, with N-methylpyrrolidone (NMP) added; and were uniformly stirred by a vacuum mixer to obtain a positive electrode slurry with a solid content of 70 wt %. The positive electrode slurry was uniformly applied to upper and lower surfaces of a positive electrode current collector aluminum foil with a thickness of 9 μm, which was dried, pressed, and cut into a predetermined size to obtain a positive electrode.

### <Preparation of Negative Electrode>

Artificial graphite, styrene-butadiene rubber (SBR), polyacrylic acid (PAA), carbon nanotubes (CNT), and carboxymethyl cellulose (CMC) were mixed in a mass ratio of 95.8:2.4:0.5:0.5:0.8, with deionized water added as a solvent; and then stirred uniformly to prepare a negative electrode slurry with a solid content of 45 wt %. The negative electrode slurry was uniformly applied to upper and lower surfaces of a negative electrode current collector copper foil with a thickness of 6 μm, which was dried, pressed, and cut into a predetermined size to obtain a negative electrode.

### <Separator>

A porous polyethylene film with a thickness of 15 μm was used as the separator.

### <Preparation of Electrochemical Apparatus>

The positive electrode, separator, negative electrode, and separator prepared above were stacked in order with the separator positioned between the positive electrode and the negative electrode for isolation, and then wound to obtain an electrode assembly. After welding tabs, the electrode assembly was placed in an aluminum-plastic film packaging bag, and dried in a vacuum oven at 85° C. for 12 hours to remove moisture. The prepared electrolyte was injected. After vacuum sealing, standing, formation, shaping, and capacity test, a lithium-ion battery was obtained.

### Examples 1-2 to 1-24

These examples were the same as Example 1-1 except that the relevant preparation parameters were adjusted according to Table 1.

### Comparative Examples 1 to 10

These comparative examples were the same as Example 1-1 except that the relevant preparation parameters were adjusted according to Table 1.

TABLE 1

| | Electrolyte components | | | | | Impedance | Capacity | | |
|---|---|---|---|---|---|---|---|---|---|
| | Ethylene | Propylene | Diethyl | Propyl | | increase | retention | | Hot-box |
| | carbonate | carbonate | carbonate | propionate | | rate after | rate after | 40D floating | test |
| | percentage | percentage | percentage | percentage | (C + D)/ | 400 cls at | 400 cls at | charge at | result at |
| Group | A (%) | B (%) | C (%) | D (%) | (A + B) | 45° C. (%) | 45° C. (%) | 45° C. (%) | 135° C. |
| Example 1-1 | 10 | 16 | 15 | 18 | 1.27 | 150 | 80 | 12 | 10/10 pass |
| Example 1-2 | 12 | 16 | 15 | 18 | 1.18 | 150 | 80 | 12 | 10/10 pass |
| Example 1-3 | 16 | 16 | 15 | 18 | 1.03 | 148 | 80.5 | 13 | 8/10 pass |
| Example 1-4 | 18 | 16 | 15 | 19 | 1.00 | 146 | 81 | 13 | 7/10 pass |
| Example 1-5 | 20 | 16 | 15 | 21 | 1.00 | 145 | 81.5 | 15 | 3/10 pass |
| Example 1-6 | 15 | 9 | 15 | 15 | 1.25 | 144 | 82 | 13 | 4/10 pass |
| Example 1-7 | 15 | 10 | 15 | 15 | 1.20 | 145 | 82 | 13 | 5/10 pass |
| Example 1-8 | 15 | 12 | 15 | 18 | 1.22 | 147 | 81.5 | 13 | 6/10 pass |
| Example 1-9 | 15 | 13 | 15 | 18 | 1.18 | 147 | 81 | 13 | 6/10 pass |
| Example 1-10 | 15 | 15 | 15 | 18 | 1.10 | 148 | 81 | 13 | 7/10 pass |
| Example 1-11 | 15 | 16 | 10 | 21 | 1.00 | 151 | 80 | 12 | 7/10 pass |
| Example 1-12 | 15 | 16 | 12 | 21 | 1.06 | 150 | 80.5 | 12 | 7/10 pass |
| Example 1-13 | 15 | 16 | 14 | 18 | 1.03 | 149 | 81 | 13 | 7/10 pass |
| Example 1-14 | 15 | 16 | 16 | 18 | 1.10 | 148 | 81 | 13 | 7/10 pass |
| Example 1-15 | 15 | 16 | 18 | 18 | 1.16 | 146 | 81.5 | 13 | 7/10 pass |
| Example 1-16 | 15 | 16 | 20 | 18 | 1.23 | 144 | 81.5 | 14 | 7/10 pass |
| Example 1-17 | 15 | 12 | 18 | 10 | 1.04 | 145 | 82 | 14 | 6/10 pass |
| Example 1-18 | 15 | 16 | 18 | 13 | 1.00 | 146 | 82 | 14 | 6/10 pass |
| Example 1-19 | 15 | 16 | 18 | 15 | 1.06 | 147 | 81.5 | 14 | 6/10 pass |
| Example 1-20 | 15 | 16 | 18 | 18 | 1.16 | 148 | 81.5 | 14 | 6/10 pass |
| Example 1-21 | 15 | 16 | 18 | 20 | 1.23 | 149 | 81.5 | 14 | 6/10 pass |
| Example 1-22 | 15 | 16 | 18 | 22 | 1.29 | 151 | 81 | 14 | 6/10 pass |
| Example 1-23 | 15 | 16 | 15 | 25 | 1.29 | 153 | 80.5 | 14 | 6/10 pass |
| Example 1-24 | 10 | 10 | 12 | 14 | 1.30 | 151 | 80 | 11 | 7/10 pass |
| Comparative | 8 | 16 | 15 | 18 | 1.38 | 168 | 76.5 | 10 | 10/10 pass |
| example 1 | | | | | | | | | |
| Comparative | 22 | 16 | 15 | 18 | 0.87 | 160 | 77 | 20 | 0/10 pass |
| example 2 | | | | | | | | | |
| Comparative | 15 | 8 | 15 | 18 | 1.43 | 157 | 78 | 13 | 2/10 pass |
| example 3 | | | | | | | | | |
| Comparative | 15 | 16 | 15 | 18 | 1.06 | 165 | 75 | 14 | 7/10 pass |
| example 4 | | | | | | | | | |
| Comparative | 15 | 16 | 8 | 21 | 0.94 | 165 | 75 | 13 | 2/10 pass |
| example 5 | | | | | | | | | |
| Comparative | 15 | 16 | 22 | 18 | 1.29 | 156 | 79 | 16 | 7/10 pass |
| example 6 | | | | | | | | | |
| Comparative | 15 | 16 | 15 | 9 | 0.77 | 161 | 77 | 13 | 8/10 pass |
| example 7 | | | | | | | | | |
| Comparative | 15 | 16 | 15 | 26 | 1.32 | 170 | 73 | 13 | 6/10 pass |
| example 8 | | | | | | | | | |
| Comparative | 15 | 16 | 15 | 15 | 0.97 | 163 | 76 | 14 | 7/10 pass |
| example 9 | | | | | | | | | |
| Comparative | 10 | 16 | 15 | 20 | 1.35 | 168 | 74 | 12 | 9/10 pass |
| example 10 | | | | | | | | | |

### Example 2-1

This example was the same as Example 1-7 except that succinonitrile was further added in <preparation of electrolyte> and the relevant preparation parameters were adjusted according to Table 2. When the mass percentage of succinonitrile changed, the percentage of LiPF₆ remained unchanged.

### Examples 2-2 to 2-9

These examples were the same as Example 2-1 except that the relevant preparation parameters were adjusted according to Table 2.

TABLE 2

| | Electrolyte components | | | | | | Impedance | Capacity | | |
|---|---|---|---|---|---|---|---|---|---|---|
| | Ethylene | Propylene | Diethyl | Propyl | | | increase | retention | | Hot-box |
| | carbonate | carbonate | carbonate | propionate | Succinonitrile | | rate after | rate after | 40D floating | test |
| | percentage | percentage | percentage | percentage | percentage | | 400 cls at | 400 cls at | charge at | result at |
| Group | A (%) | B (%) | C (%) | D (%) | G (%) | D/G | 45° C. (%) | 45° C. (%) | 45° C. (%) | 135° C. |
| Example | 15 | 10 | 15 | 15 | 0 | — | 145 | 82 | 13 | 5/10 |
| 1-7 | | | | | | | | | | pass |
| Example | 15 | 10 | 15 | 15 | 2 | 7.50 | 130 | 85 | 10 | 7/10 |
| 2-1 | | | | | | | | | | pass |
| Example | 15 | 10 | 15 | 15 | 2.2 | 6.82 | 129 | 85.5 | 10 | 7/10 |
| 2-2 | | | | | | | | | | pass |
| Example | 15 | 10 | 15 | 15 | 2.4 | 6.25 | 127 | 85.5 | 9 | 7/10 |
| 2-3 | | | | | | | | | | pass |
| Example | 15 | 10 | 15 | 15 | 2.5 | 6.00 | 125 | 86 | 8 | 7/10 |
| 2-4 | | | | | | | | | | pass |
| Example | 15 | 10 | 15 | 15 | 2.8 | 5.36 | 128 | 85.5 | 8 | 7/10 |
| 2-5 | | | | | | | | | | pass |
| Example | 15 | 10 | 15 | 15 | 3 | 5.00 | 131 | 85 | 7 | 8/10 |
| 2-6 | | | | | | | | | | pass |
| Example | 15 | 10 | 15 | 15 | 3.5 | 4.29 | 137 | 84 | 6 | 7/10 |
| 2-7 | | | | | | | | | | pass |
| Example | 15 | 16 | 18 | 15 | 5 | 3 | 144 | 83 | 6 | 7/10 |
| 2-8 | | | | | | | | | | pass |
| Example | 15 | 16 | 14 | 18 | 2.25 | 8 | 128 | 85.5 | 10 | 7/10 |
| 2-9 | | | | | | | | | | pass |

### Example 3-1

This example was the same as Example 1-7 except that 1,3,6-hexanetricarbonitrile was further added in <preparation of electrolyte> and the relevant preparation parameters were adjusted according to Table 3. When the mass percentage of 1,3,6-hexanetricarbonitrile changed, the percentage of LiPF₆ remained unchanged.

### Examples 3-2 to 3-9

These examples were the same as Example 3-1 except that the relevant preparation parameters were adjusted according to Table 3.

TABLE 3

| | Electrolyte components | | | | | | Impedance | Capacity | | |
|---|---|---|---|---|---|---|---|---|---|---|
| | Ethylene | | | | 1,3,6- | | increase | retention | | Hot-box |
| | carbonate | Propylene | Diethyl | Propyl | hexanetricarbonitrile | | rate after | rate after | 40D floating | test |
| | percentage | percentage | percentage | percentage | percentage | | 400 cls at | 400 cls at | charge at | result at |
| Group | A (%) | B (%) | C (%) | D (%) | H (%) | D/H | 45° C. (%) | 45° C. (%) | 45° C. (%) | 135° C. |
| Example | 15 | 10 | 15 | 15 | 0 | — | 145 | 82 | 13 | 5/10 |
| 1-7 | | | | | | | | | | pass |
| Example | 15 | 10 | 15 | 15 | 2 | 7.50 | 133 | 85 | 9 | 7/10 |
| 3-1 | | | | | | | | | | pass |
| Example | 15 | 10 | 15 | 15 | 2.2 | 6.82 | 131 | 85.5 | 9 | 9/10 |
| 3-2 | | | | | | | | | | pass |
| Example | 15 | 10 | 15 | 15 | 2.5 | 6.00 | 130 | 85.5 | 8 | 10/10 |
| 3-3 | | | | | | | | | | pass |
| Example | 15 | 10 | 15 | 15 | 3 | 5.00 | 130 | 86 | 8 | 10/10 |
| 3-4 | | | | | | | | | | pass |
| Example | 15 | 10 | 15 | 15 | 3.5 | 4.29 | 135 | 85 | 6 | 10/10 |
| 3-5 | | | | | | | | | | pass |
| Example | 15 | 10 | 15 | 15 | 4 | 3.75 | 138 | 84 | 5 | 10/10 |
| 3-6 | | | | | | | | | | pass |
| Example | 15 | 10 | 15 | 15 | 4.5 | 3.33 | 143 | 83 | 5 | 10/10 |
| 3-7 | | | | | | | | | | pass |
| Example | 15 | 12 | 18 | 10 | 5 | 2 | 140 | 83 | 5 | 10/10 |
| 3-8 | | | | | | | | | | pass |
| Example | 15 | 16 | 10 | 21 | 3 | 7 | 180 | 86 | 9 | 10/10 |
| 3-9 | | | | | | | | | | pass |

### Example 4-1

This example was the same as Example 1-7 except that trimethylacetonitrile and/or fluoroacetonitrile were further added in <preparation of electrolyte> and the relevant preparation parameters were adjusted according to Table 4. When the mass percentages of trimethylacetonitrile and fluoroacetonitrile changed, the percentage of LiPF₆ remained unchanged.

### Examples 4-2 to 4-21

These examples were the same as Example 4-1 except that the relevant preparation parameters were adjusted according to Table 4.

TABLE 4

| | Electrolyte components | | | | | | Impedance | Capacity | | |
|---|---|---|---|---|---|---|---|---|---|---|
| | Ethylene | Propylene | Diethyl | Propyl | | Fluoroace- | increase | retention | | Hot-box |
| | carbonate | carbonate | carbonate | propionate | Trimethylacetonitrile | tonitrile | rate after | rate after | 40D floating | test |
| | percentage | percentage | percentage | percentage | percentage | percentage | 400 cls at | 400 cls at | charge at | result at |
| Group | A (%) | B (%) | C (%) | D (%) | J (%) | K (%) | 45° C. (%) | 45° C. (%) | 45° C. (%) | 135° C. |
| Example | 15 | 10 | 15 | 15 | 0 | 0 | 145 | 82 | 13 | 5/10 |
| 1-7 | | | | | | | | | | pass |
| Example | 15 | 10 | 15 | 15 | 0.05 | 0 | 143 | 83 | 13 | 5/10 |
| 4-1 | | | | | | | | | | pass |
| Example | 15 | 10 | 15 | 15 | 0.1 | 0 | 141 | 83.5 | 13 | 5/10 |
| 4-2 | | | | | | | | | | pass |
| Example | 15 | 10 | 15 | 15 | 0.2 | 0 | 140 | 84 | 13 | 5/10 |
| 4-3 | | | | | | | | | | pass |
| Example | 15 | 10 | 15 | 15 | 0.3 | 0 | 137 | 86 | 13 | 5/10 |
| 4-4 | | | | | | | | | | pass |
| Example | 15 | 10 | 15 | 15 | 0.4 | 0 | 136 | 86 | 13 | 5/10 |
| 4-5 | | | | | | | | | | pass |
| Example | 15 | 10 | 15 | 15 | 0.5 | 0 | 135 | 85 | 12 | 6/10 |
| 4-6 | | | | | | | | | | pass |
| Example | 15 | 10 | 15 | 15 | 0.6 | 0 | 140 | 83 | 12 | 6/10 |
| 4-7 | | | | | | | | | | pass |
| Example | 15 | 10 | 15 | 15 | 0 | 0.08 | 144 | 82.5 | 13 | 5/10 |
| 4-8 | | | | | | | | | | pass |
| Example | 15 | 10 | 15 | 15 | 0 | 0.1 | 142 | 83 | 13 | 5/10 |
| 4-9 | | | | | | | | | | pass |
| Example | 15 | 10 | 15 | 15 | 0 | 0.8 | 140 | 83.5 | 13 | 5/10 |
| 4-10 | | | | | | | | | | pass |
| Example | 15 | 10 | 15 | 15 | 0 | 1 | 139 | 84 | 13 | 5/10 |
| 4-11 | | | | | | | | | | pass |
| Example | 15 | 10 | 15 | 15 | 0 | 1.5 | 137 | 84 | 13 | 5/10 |
| 4-12 | | | | | | | | | | pass |
| Example | 15 | 10 | 15 | 15 | 0 | 2 | 134 | 84.5 | 13 | 5/10 |
| 4-13 | | | | | | | | | | pass |
| Example | 15 | 10 | 15 | 15 | 0 | 2.5 | 130 | 85 | 13 | 5/10 |
| 4-14 | | | | | | | | | | pass |
| Example | 15 | 10 | 15 | 15 | 0 | 3 | 128 | 85.5 | 13 | 5/10 |
| 4-15 | | | | | | | | | | pass |
| Example | 15 | 10 | 15 | 15 | 0 | 3.5 | 125 | 86 | 13 | 5/10 |
| 4-16 | | | | | | | | | | pass |
| Example | 15 | 10 | 15 | 15 | 0 | 4 | 123 | 86.5 | 13 | 5/10 |
| 4-17 | | | | | | | | | | pass |
| Example | 15 | 10 | 15 | 15 | 0 | 4.5 | 122 | 87 | 13 | 5/10 |
| 4-18 | | | | | | | | | | pass |
| Example | 15 | 10 | 15 | 15 | 0 | 5 | 125 | 86 | 13 | 5/10 |
| 4-19 | | | | | | | | | | pass |
| Example | 15 | 10 | 15 | 15 | 0 | 5.2 | 134 | 83 | 13 | 5/10 |
| 4-20 | | | | | | | | | | pass |
| Example | 15 | 10 | 15 | 15 | 0.5 | 2.6 | 120 | 88 | 12 | 6/10 |
| 4-21 | | | | | | | | | | pass |

### Example 5-1

This example was the same as Example 1-7 except that the positive electrode was prepared in the following manner.

### <Preparation of Positive Electrode>

Lithium cobalt oxide doped with the titanium element, conductive agent conductive carbon black, and polyvinylidene fluoride (PVDF) were mixed in a mass ratio of 95:2:3, with N-methylpyrrolidone (NMP) added; and was uniformly stirred by a vacuum mixer to obtain a positive electrode slurry with a solid content of 70 wt %. The positive electrode slurry was uniformly applied to upper and lower surfaces of a positive electrode current collector aluminum foil with a thickness of 9 μm, which was dried, pressed, and cut into a predetermined size to obtain a positive electrode. In the obtained positive electrode, based on a total mass of the positive electrode, a content of the titanium element was 4000 ppm.

### Examples 5-2 to 5-6

These examples were the same as Example 5-1 except that the relevant preparation parameters of the positive electrode were adjusted according to Table 5.

### Example 5-7

This example was the same as Example 1-7 except that the positive electrode was prepared in the following manner.

### <Preparation of Positive Electrode>

Lithium cobalt oxide doped with the magnesium element, conductive agent conductive carbon black, and polyvinylidene fluoride (PVDF) were mixed in a mass ratio of 95:2:3, with N-methylpyrrolidone (NMP) added; and was uniformly stirred by a vacuum mixer to obtain a positive electrode slurry with a solid content of 70 wt %. The positive electrode slurry was uniformly applied to upper and lower surfaces of a positive electrode current collector aluminum foil with a thickness of 9 μm, which was dried, pressed, and cut into a predetermined size to obtain a positive electrode. In the obtained positive electrode, based on a total mass of the positive electrode, a content of the magnesium element was 4000 ppm.

### Examples 5-8 to 5-12

These examples were the same as Example 5-7 except that the relevant preparation parameters of the positive electrode were adjusted according to Table 5.

### Example 5-13

This example was the same as Example 1-7 except that the positive electrode was prepared in the following manner.

### <Preparation of Positive Electrode>

Lithium cobalt oxide doped with the aluminum element, conductive agent conductive carbon black, and polyvinylidene fluoride (PVDF) were mixed in a mass ratio of 95:2:3, with N-methylpyrrolidone (NMP) added; and were uniformly stirred by a vacuum mixer to obtain a positive electrode slurry with a solid content of 70 wt %. The positive electrode slurry was uniformly applied to upper and lower surfaces of a positive electrode current collector aluminum foil with a thickness of 9 μm, which was dried, pressed, and cut into a predetermined size to obtain a positive electrode. In the obtained positive electrode, based on a total mass of the positive electrode, a content of the aluminum element was 4000 ppm.

### Examples 5-14 to 5-18

These examples were the same as Example 5-13 except that the relevant preparation parameters of the positive electrode were adjusted according to Table 5.

TABLE 5

| | Electrolyte components | | | | Positive electrode | | Impedance | Capacity | | |
|---|---|---|---|---|---|---|---|---|---|---|
| | Ethylene | Propylene | Diethyl | Propyl | doping | | increase | retention | 40D floating | Hot-box |
| | carbonate | carbonate | carbonate | propionate | element | | rate after | rate after | charge at | test |
| | percentage | percentage | percentage | percentage | | Content M | 400 cls at | 400 cls at | 45° C. | result at |
| Group | A (%) | B (%) | C (%) | D (%) | Type | (ppm) | 45° C. (%) | 45° C. (%) | (%) | 135° C. |
| Example 1-7 | 15 | 10 | 15 | 15 | None | — | 145 | 82 | 13 | 5/10 pass |
| Example 5-1 | 15 | 10 | 15 | 15 | Titanium | 4000 | 142 | 83 | 13 | 5/10 pass |
| Example 5-2 | 15 | 10 | 15 | 15 | Titanium | 5000 | 141 | 83.5 | 13 | 5/10 pass |
| Example 5-3 | 15 | 10 | 15 | 15 | Titanium | 6000 | 140 | 83.5 | 13 | 5/10 pass |
| Example 5-4 | 15 | 10 | 15 | 15 | Titanium | 7000 | 138 | 84 | 12 | 6/10 pass |
| Example 5-5 | 15 | 10 | 15 | 15 | Titanium | 8000 | 137 | 83.5 | 13 | 6/10 pass |
| Example 5-6 | 15 | 10 | 15 | 15 | Titanium | 8500 | 136 | 83 | 13 | 6/10 pass |
| Example 5-7 | 15 | 10 | 15 | 15 | Magnesium | 4000 | 143 | 83.5 | 13 | 5/10 pass |
| Example 5-8 | 15 | 10 | 15 | 15 | Magnesium | 5000 | 141 | 83.5 | 13 | 5/10 pass |
| Example 5-9 | 15 | 10 | 15 | 15 | Magnesium | 6000 | 140 | 84 | 12 | 5/10 pass |
| Example 5-10 | 15 | 10 | 15 | 15 | Magnesium | 7000 | 139 | 83.5 | 12 | 6/10 pass |
| Example 5-11 | 15 | 10 | 15 | 15 | Magnesium | 8000 | 142 | 83 | 12 | 7/10 pass |
| Example 5-12 | 15 | 10 | 15 | 15 | Magnesium | 8500 | 143 | 83 | 12 | 7/10 pass |
| Example 5-13 | 15 | 10 | 15 | 15 | Aluminum | 4000 | 141 | 84 | 13 | 5/10 pass |
| Example 5-14 | 15 | 10 | 15 | 15 | Aluminum | 5000 | 138 | 85 | 13 | 5/10 pass |
| Example 5-15 | 15 | 10 | 15 | 15 | Aluminum | 6000 | 136 | 85 | 13 | 5/10 pass |
| Example 5-16 | 15 | 10 | 15 | 15 | Aluminum | 7000 | 134 | 85.5 | 12 | 7/10 pass |
| Example 5-17 | 15 | 10 | 15 | 15 | Aluminum | 8000 | 133 | 86 | 11 | 7/10 pass |
| Example 5-18 | 15 | 10 | 15 | 15 | Aluminum | 8500 | 137 | 85 | 11 | 7/10 pass |

### Example 6-1

This example was the same as Example 1-7 except that fluoroethylene carbonate and/or 1,3-propane sultone were further added in <preparation of electrolyte> and the relevant preparation parameters were adjusted according to Table 6. When the mass percentages of fluoroethylene carbonate and 1,3-propane sultone changed, the percentage of LiPF₆ remained unchanged.

### Examples 6-2 to 6-11

These examples were the same as Example 6-1 except that the relevant preparation parameters were adjusted according to Table 6.

TABLE 6

| | | | | | | | Impedance | Capacity | | |
|---|---|---|---|---|---|---|---|---|---|---|
| | Electrolyte components | | | | | | increase | retention | | |
| | Ethylene | Propylene | Diethyl | Propyl | Fluoroethylene | 1,3-propane | rate after | rate after | 40D floating | Hot-box |
| | carbonate | carbonate | carbonate | propionate | carbonate | sultone | 400 cls | 400 cls | charge at | test |
| | percentage | percentage | percentage | percentage | percentage | percentage | at 45° C. | at 45° C. | 45° C. | result at |
| Group | A (%) | B (%) | C (%) | D (%) | E (%) | F (%) | (%) | (%) | (%) | 135° C. |
| Example | 15 | 10 | 15 | 15 | 0 | 0 | 145 | 82 | 13 | 5/10 |
| 1-7 | | | | | | | | | | pass |
| Example | 15 | 10 | 15 | 15 | 1 | 0 | 143 | 83.5 | 13 | 5/10 |
| 6-1 | | | | | | | | | | pass |
| Example | 15 | 10 | 15 | 15 | 2 | 0 | 140 | 84 | 13 | 5/10 |
| 6-2 | | | | | | | | | | pass |
| Example | 15 | 10 | 15 | 15 | 3 | 0 | 138 | 83.5 | 13 | 4/10 |
| 6-3 | | | | | | | | | | pass |
| Example | 15 | 10 | 15 | 15 | 4 | 0 | 141 | 84.5 | 13 | 4/10 |
| 6-4 | | | | | | | | | | pass |
| Example | 15 | 10 | 15 | 15 | 5 | 0 | 143 | 83 | 13 | 3/10 |
| 6-5 | | | | | | | | | | pass |
| Example | 15 | 10 | 15 | 15 | 0 | 1 | 142 | 83 | 13 | 5/10 |
| 6-6 | | | | | | | | | | pass |
| Example | 15 | 10 | 15 | 15 | 0 | 2 | 138 | 84 | 13 | 5/10 |
| 6-7 | | | | | | | | | | pass |
| Example | 15 | 10 | 15 | 15 | 0 | 3 | 137 | 86 | 13 | 5/10 |
| 6-8 | | | | | | | | | | pass |
| Example | 15 | 10 | 15 | 15 | 0 | 3.5 | 139 | 85 | 13 | 5/10 |
| 6-9 | | | | | | | | | | pass |
| Example | 15 | 10 | 15 | 15 | 0 | 4 | 143 | 84 | 13 | 5/10 |
| 6-10 | | | | | | | | | | pass |
| Example | 15 | 10 | 15 | 15 | 2 | 2 | 133 | 88 | 13 | 5/10 |
| 6-11 | | | | | | | | | | pass |

### Example 7-1

This example was the same as Example 1-7 except that lithium tetrafluoroborate was further added in <preparation of electrolyte> and the relevant preparation parameters were adjusted according to Table 7. When the mass percentage of lithium tetrafluoroborate changed, the percentage of LiPF₆ remained unchanged.

### Examples 7-2 to 7-5

These examples were the same as Example 7-1 except that the relevant preparation parameters were adjusted according to Table 7.

TABLE 7

| | Electrolyte components | | | | | Impedance | Capacity | 40D | |
|---|---|---|---|---|---|---|---|---|---|
| | Ethylene | Propylene | Diethyl | Propyl | Lithium | increase | retention | floating | Hot-box |
| | carbonate | carbonate | carbonate | propionate | tetrafluoroborate | rate after | rate after | charge | test |
| | percentage | percentage | percentage | percentage | percentage | 400 cls at | 400 cls at | at 45° C. | result at |
| Group | A (%) | B (%) | C (%) | D (%) | I (%) | 45° C. (%) | 45° C. (%) | (%) | 135° C. |
| Example 1-7 | 15 | 10 | 15 | 15 | 0 | 145 | 82 | 13 | 5/10 pass |
| Example 7-1 | 15 | 10 | 15 | 15 | 0.01 | 139 | 85 | 13 | 5/10 pass |
| Example 7-2 | 15 | 10 | 15 | 15 | 0.08 | 138 | 86 | 13 | 5/10 pass |
| Example 7-3 | 15 | 10 | 15 | 15 | 0.1 | 136 | 86.5 | 13 | 5/10 pass |
| Example 7-4 | 15 | 10 | 15 | 15 | 0.18 | 137 | 85 | 13 | 5/10 pass |
| Example 7-5 | 15 | 10 | 15 | 15 | 0.2 | 138 | 84 | 13 | 5/10 pass |

As can be learned from Table 1, when the non-aqueous electrolyte in this application is used in an electrochemical apparatus, the impedance increase of the electrochemical apparatus during cycling can be effectively suppressed, improving the cycling performance of the electrochemical apparatus.

As can be learned from Table 2, when 2% to 3.5% of succinonitrile is added to the non-aqueous electrolyte or D/G is in the range of 3 to 8, the floating charge performance of the electrochemical apparatus can be significantly improved, and the impedance increase rate of the electrochemical apparatus during cycling can be further suppressed.

As can be learned from Table 3, when 2% to 4.5% of 1,3,6-hexanetricarbonitrile was added to the non-aqueous electrolyte or D/H is in the range of 2 to 7, the hot-box performance of the electrochemical apparatus can be significantly improved.

As can be learned from Table 4, when trimethylacetonitrile or fluoroacetonitrile is added to the non-aqueous electrolyte, the high-temperature cycling performance of the electrochemical apparatus can be significantly improved; in particular, when the mass percentage of trimethylacetonitrile is 0.1% to 0.5%, or the mass percentage of fluoroacetonitrile is 0.1% to 5%, or both trimethylacetonitrile and fluoroacetonitrile are added, the high-temperature cycling performance of the electrochemical apparatus is improved more significantly.

As can be learned from Table 5, when the positive electrode contains doping elements such as the titanium element, the magnesium element, and the aluminum element, and a total content of the doping elements is 4000 ppm to 8500 ppm, the electrochemical apparatus not only has a relatively low impedance increase during cycling but also exhibits good high-temperature cycling performance.

As can be learned from Table 6, when fluoroethylene carbonate and/or 1,3-propane sultone is added to the non-aqueous electrolyte, the high-temperature cycling performance of the electrochemical apparatus can be improved; in particular, when the mass percentage of fluoroethylene carbonate is 2% to 4%, or the mass percentage of 1,3-propane sultone is 2% to 3.5%, or both fluoroethylene carbonate and 1,3-propane sultone are added, the high-temperature cycling performance of the electrochemical apparatus is improved more significantly.

As can be learned from Table 7, when 0.01% to 0.2% of lithium tetrafluoroborate is added to the non-aqueous electrolyte, the cycling performance of the electrochemical apparatus can be further improved.

The above descriptions are only embodiments of this application and are not intended to limit the protection scope of this application. For those skilled in the art, various modifications and changes may be made to this application. Any modification, equivalent replacement, improvement, and the like made within the spirit and principle of this application shall be included in the protection scope of this application.

What is claimed is:

1. Anon-aqueous electrolyte, comprising ethylene carbonate, propylene carbonate, diethyl carbonate, and propyl propionate; wherein based on a total mass of the non-aqueous electrolyte, a mass percentage of the ethylene carbonate is A %, a mass percentage of the propylene carbonate is B %, a mass percentage of the diethyl carbonate is C %, and a mass percentage of the propyl propionate is D %, 10≤A≤20, 9≤B≤15, 10≤C≤20, 10≤D≤25, and 1≤(C+D)/(A+B)≤1.3.

2. The non-aqueous electrolyte according to claim 1, wherein the non-aqueous electrolyte further comprises succinonitrile; based on the total mass of the non-aqueous electrolyte, a mass percentage of the succinonitrile is G %; and 3≤D/G≤8, and/or 2≤G≤3.5.

3. The non-aqueous electrolyte according to claim 1, wherein the non-aqueous electrolyte further comprises 1,3,6-hexanetricarbonitrile; based on the total mass of the non-aqueous electrolyte, a mass percentage of the 1,3,6-hexanetricarbonitrile is H %; and 2≤D/H≤7, and/or 2≤H≤4.5.

4. The non-aqueous electrolyte according to claim 1, wherein the non-aqueous electrolyte further comprises fluoroethylene carbonate and/or 1,3-propane sultone.

5. The non-aqueous electrolyte according to claim 4, wherein the non-aqueous electrolyte comprises the fluoroethylene carbonate; based on the total mass of the non-aqueous electrolyte, a mass percentage of the fluoroethylene carbonate is E %, and 2≤E≤4; and/or
the non-aqueous electrolyte comprises the 1,3-propane sultone; based on the total mass of the non-aqueous electrolyte, a mass percentage of the 1,3-propane sultone is F %, and 2≤F≤3.5.

6. The non-aqueous electrolyte according to claim 1, wherein the non-aqueous electrolyte comprises lithium tetrafluoroborate; based on the total mass of the non-aqueous electrolyte, a mass percentage of the lithium tetrafluoroborate is I %, and 0.01≤I≤0.2.

7. The non-aqueous electrolyte according to claim 1, wherein the non-aqueous electrolyte further comprises trimethylacetonitrile and/or fluoroacetonitrile.

8. The non-aqueous electrolyte according to claim 7, wherein the non-aqueous electrolyte comprises the trimethylacetonitrile; based on the total mass of the non-aqueous electrolyte, a mass percentage of the trimethylacetonitrile is J %, and 0.1≤J≤0.5; and/or
the non-aqueous electrolyte comprises the fluoroacetonitrile; based on the total mass of the non-aqueous electrolyte, a mass percentage of the fluoroacetonitrile is K %, and 0.1≤K≤5.

9. An electrochemical apparatus, comprising a positive electrode, a negative electrode, and a non-aqueous electrolyte; the non-aqueous electrolyte comprises ethylene carbonate, propylene carbonate, diethyl carbonate, and propyl propionate; wherein based on a total mass of the non-aqueous electrolyte, a mass percentage of the ethylene carbonate is A %, a mass percentage of the propylene carbonate is B %, a mass percentage of the diethyl carbonate is C %, and a mass percentage of the propyl propionate is D %, 10≤A≤20, 9≤B≤15, 10≤C≤20, 10≤D≤25, and 1≤(C+D)/(A+B)≤1.3.

10. The electrochemical apparatus according to claim 9, wherein the non-aqueous electrolyte further comprises succinonitrile; based on the total mass of the non-aqueous electrolyte, a mass percentage of the succinonitrile is Go; and 3≤D/G≤8, and/or 2≤G≤3.5.

11. The electrochemical apparatus according to claim 9, wherein the non-aqueous electrolyte further comprises 1,3,6-hexanetricarbonitrile; based on the total mass of the non-aqueous electrolyte, a mass percentage of the 1,3,6-hexanetricarbonitrile is H %; and 2≤D/H≤7, and/or 2≤H≤4.5.

12. The electrochemical apparatus according to claim 9, wherein the non-aqueous electrolyte further comprises fluoroethylene carbonate and/or 1,3-propane sultone.

13. The electrochemical apparatus according to claim 12, wherein the non-aqueous electrolyte comprises the fluoroethylene carbonate; based on the total mass of the non-aqueous electrolyte, a mass percentage of the fluoroethylene carbonate is E %, and 2≤E≤4; and/or
the non-aqueous electrolyte comprises the 1,3-propane sultone; based on the total mass of the non-aqueous electrolyte, a mass percentage of the 1,3-propane sultone is F %, and 2≤F≤3.5.

14. The electrochemical apparatus according to claim 9, wherein the non-aqueous electrolyte further comprises lithium tetrafluoroborate; based on the total mass of the non-aqueous electrolyte, a mass percentage of the lithium tetrafluoroborate is I %, and 0.01≤I≤0.2.

15. The electrochemical apparatus according to claim 10, wherein the non-aqueous electrolyte further comprises lithium tetrafluoroborate; based on the total mass of the non-aqueous electrolyte, a mass percentage of the lithium tetrafluoroborate is I %, and 0.01≤I≤0.2.

16. The electrochemical apparatus according to claim 11, wherein the non-aqueous electrolyte further comprises lithium tetrafluoroborate; based on the total mass of the non-aqueous electrolyte, a mass percentage of the lithium tetrafluoroborate is I %, and 0.01≤I≤0.2.

17. The electrochemical apparatus according to claim 9, wherein the non-aqueous electrolyte further comprises trimethylacetonitrile and/or fluoroacetonitrile.

18. The electrochemical apparatus according to claim 17, wherein the non-aqueous electrolyte comprises trimethylacetonitrile; based on the total mass of the non-aqueous electrolyte, a mass percentage of the trimethylacetonitrile is J %, and 0.1≤J≤0.5; and/or
the non-aqueous electrolyte comprises fluoroacetonitrile; based on the total mass of the non-aqueous electrolyte, a mass percentage of the fluoroacetonitrile is K %, and 0.1≤K≤5.

19. The electrochemical apparatus according to claim 9, wherein the positive electrode comprises a positive electrode current collector and a positive electrode active material layer located on at least one surface of the positive electrode current collector; the positive electrode active material layer comprises a doping element; wherein the doping element comprises at least one of the titanium element, the magnesium element, or the aluminum element; and based on a total mass of the positive electrode, a content of the doping element is M ppm, and 4000≤M≤8500.

20. An electronic apparatus, comprising an electrochemical apparatus, the electrochemical apparatus comprises a positive electrode, a negative electrode, and a non-aqueous electrolyte; the non-aqueous electrolyte comprises ethylene carbonate, propylene carbonate, diethyl carbonate, and propyl propionate; wherein based on a total mass of the non-aqueous electrolyte, a mass percentage of the ethylene carbonate is A %, a mass percentage of the propylene carbonate is B %, a mass percentage of the diethyl carbonate is C %, and a mass percentage of the propyl propionate is D %, 10≤A≤20, 9≤B≤15, 10≤C≤20, 10≤D≤25, and 1≤(C+D)/(A+B)≤1.3.
